(19) United States
(12) Patent Application Publication
(10) Pub. No.: US 2025/0168754 A1
(43) Pub. Date: May 22, 2025

(54) REQUESTING AERIAL SUBSCRIPTION INFORMATION

(71) Applicant: Lenovo (Singapore) Pte. Ltd., New Tech Park (SG)

(72) Inventors: Roozbeh Atarius, La Jolla, CA (US); Hyung-Nam Choi, Ottobrunn (DE); Dimitrios Karampatsis, Ruislip (GB)

(21) Appl. No.: 18/838,949

(22) PCT Filed: Mar. 23, 2022
(86) PCT No.: PCT/EP2022/057711

§ 371 Date: Aug. 15, 2024

(30) Foreign Application Priority Data
Feb. 17, 2022 (GR) 20220100149

(51) Int. Cl. H04W 48/16; H04B 7/185; H04L 67/141; H04W 12/06

(52) U.S. Cl. CPC H04W 48/16; H04B 7/18504; H04L 67/141; H04W 12/06

(57) ABSTRACT

Apparatuses, methods, and systems are disclosed for requesting aerial subscription information. One method includes receiving, at a first network entity, a non-access stratum (NAS) transport message from a user equipment (UE). The NAS transport message includes: a protocol data unit (PDU) session establishment request message; and an indication indicating whether the PDU session establishment request message is for an uncrewed aerial system service supplier (USS) uncrewed aerial vehicle (UAV) authorization and authentication (UUAA). The method includes determining, at the first network entity, whether the indication indicates that the PDU session establishment request message is for the UUAA. The method includes, in response to determining that the indication indicates that the PDU session establishment request message is for the UUAA, transmitting, from the first network entity, a request to a second network entity for an aerial subscription of the UE.

### FIELD

The subject matter disclosed herein relates generally to wireless communications and more particularly relates to requesting aerial subscription information.

### BACKGROUND

In certain wireless communications networks, aerial subscription information may be obtained. In such networks, different devices may request the aerial subscription information.

### BRIEF SUMMARY

Methods for requesting aerial subscription information are disclosed. Apparatuses and systems also perform the functions of the methods. One embodiment of a method includes receiving, at a first network entity, a non-access stratum (NAS) transport message from a user equipment (UE). The NAS transport message includes: a protocol data unit (PDU) session establishment request message; and an indication indicating whether the PDU session establishment request message is for an uncrewed aerial system service supplier (USS) uncrewed aerial vehicle (UAV) authorization and authentication (UUAA). In some embodiments, the method includes determining, at the first network entity, whether the indication indicates that the PDU session establishment request message is for the UUAA. In certain embodiments, the method includes, in response to determining that the indication indicates that the PDU session establishment request message is for the UUAA, transmitting, from the first network entity, a request to a second network entity for an aerial subscription of the UE.

One apparatus for requesting aerial subscription information includes a first network entity. In some embodiments, the apparatus includes a receiver that receives, at the first network entity, a non-access stratum (NAS) transport message from a user equipment (UE). The NAS transport message includes: a protocol data unit (PDU) session establishment request message; and an indication indicating whether the PDU session establishment request message is for an uncrewed aerial system service supplier (USS) uncrewed aerial vehicle (UAV) authorization and authentication (UUAA). In various embodiments, the apparatus includes a processor that determines, at the first network entity, whether the indication indicates that the PDU session establishment request message is for the UUAA. In certain embodiments, the apparatus includes a transmitter that, in response to determining that the indication indicates that the PDU session establishment request message is for the UUAA, transmits, from the first network entity, a request to a second network entity for an aerial subscription of the UE.

Another embodiment of a method for requesting aerial subscription information includes transmitting, from a UE, a non-access stratum (NAS) transport message to a first network entity. The NAS transport message includes: a protocol data unit (PDU) session establishment request message; and an indication indicating whether the PDU session establishment request message is for an uncrewed aerial system service supplier (USS) uncrewed aerial vehicle (UAV) authorization and authentication (UUAA). In some embodiments, the method includes receiving, at the UE, a response to the NAS transport message.

Another apparatus for requesting aerial subscription information includes a user equipment. In some embodiments, the apparatus includes a transmitter that transmits, from the UE, a non-access stratum (NAS) transport message to a first network entity. The NAS transport message includes: a protocol data unit (PDU) session establishment request message; and an indication indicating whether the PDU session establishment request message is for an uncrewed aerial system service supplier (USS) uncrewed aerial vehicle (UAV) authorization and authentication (UUAA). In various embodiments, the apparatus includes a receiver that receives, at the UE, a response to the NAS transport message.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for requesting aerial subscription information;

FIG. 2 is a schematic block diagram illustrating one embodiment of an apparatus that may be used for requesting aerial subscription information;

FIG. 3 is a schematic block diagram illustrating one embodiment of an apparatus that may be used for requesting aerial subscription information;

FIG. 4 is a schematic block diagram illustrating one embodiment of a system for UUAA in the context of a registration procedure (e.g., UUAA-MM);

FIG. 5 is a schematic block diagram illustrating one embodiment of a system for UUAA performed at a time of PDU session establishment in 5GS;

FIG. 6 is a schematic block diagram illustrating one embodiment of a system for obtaining aerial subscription information;

FIG. 7 is a flow chart diagram illustrating one embodiment of a method for requesting aerial subscription information; and

FIG. 8 is a flow chart diagram illustrating another embodiment of a method for requesting aerial subscription information.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

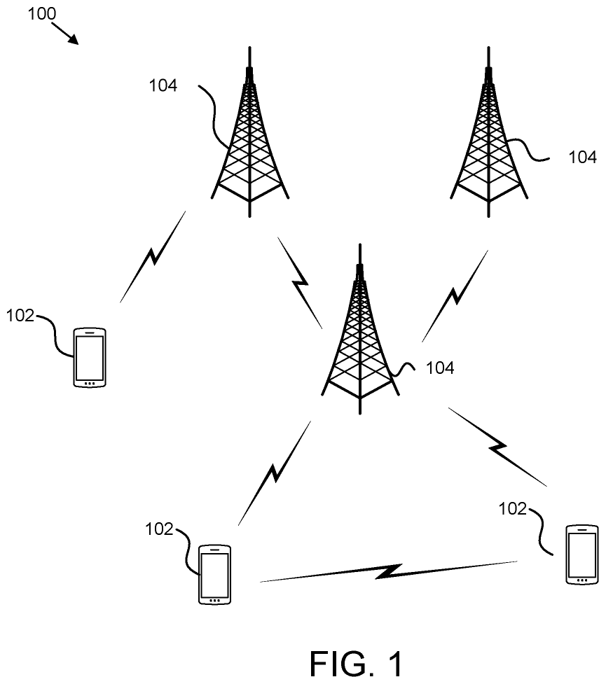

FIG. 1 depicts an embodiment of a wireless communication system 100 for requesting aerial subscription information. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an OFDM modulation scheme on the downlink (“DL”) and the remote units 102 transmit on the uplink (“UL”) using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a remote unit 102 may transmit, from a UE, a non-access stratum (NAS) transport message to a first network entity. The NAS transport message includes: a protocol data unit (PDU) session establishment request message; and an indication indicating whether the PDU session establishment request message is for an uncrewed aerial system service supplier (USS) uncrewed aerial vehicle (UAV) authorization and authentication (UUAA). In some embodiments, the remote unit 102 may receive, at the UE, a response to the NAS transport message. Accordingly, the remote unit 102 may be used for requesting aerial subscription information.

In certain embodiments, a network unit 104 may receive, at a first network entity, a non-access stratum (NAS) transport message from a user equipment (UE). The NAS transport message includes: a protocol data unit (PDU) session establishment request message; and an indication indicating whether the PDU session establishment request message is for an uncrewed aerial system service supplier (USS) uncrewed aerial vehicle (UAV) authorization and authentication (UUAA). In some embodiments, the network unit 104 may determine, at the first network entity, whether the indication indicates that the PDU session establishment request message is for the UUAA. In certain embodiments, the network unit 104 may, in response to determining that the indication indicates that the PDU session establishment request message is for the UUAA, transmit, from the first network entity, a request to a second network entity for an aerial subscription of the UE. Accordingly, the network unit 104 may be used for requesting aerial subscription information.

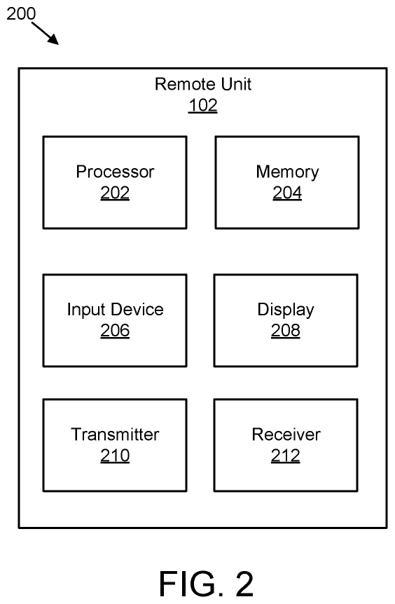

FIG. 2 depicts one embodiment of an apparatus 200 that may be used for requesting aerial subscription information. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In certain embodiments, the transmitter 210 transmits, from the UE, a non-access stratum (NAS) transport message to a first network entity. The NAS transport message includes: a protocol data unit (PDU) session establishment request message; and an indication indicating whether the PDU session establishment request message is for an uncrewed aerial system service supplier (USS) uncrewed aerial vehicle (UAV) authorization and authentication (UUAA). In various embodiments, the receiver 212 receives, at the UE, a response to the NAS transport message.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

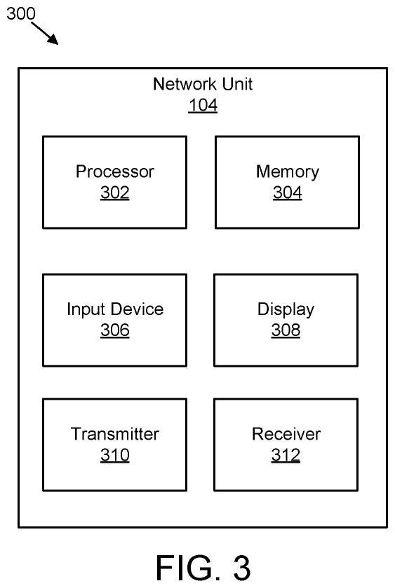

FIG. 3 depicts one embodiment of an apparatus 300 that may be used for requesting aerial subscription information. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, the receiver 312 receives, at the first network entity, a non-access stratum (NAS) transport message from a user equipment (UE). The NAS transport message includes: a protocol data unit (PDU) session establishment request message; and an indication indicating whether the PDU session establishment request message is for an uncrewed aerial system service supplier (USS) uncrewed aerial vehicle (UAV) authorization and authentication (UUAA). In various embodiments, the processor 302 determines, at the first network entity, whether the indication indicates that the PDU session establishment request message is for the UUAA. In certain embodiments, the transmitter 310, in response to determining that the indication indicates that the PDU session establishment request message is for the UUAA, transmits, from the first network entity, a request to a second network entity for an aerial subscription of the UE.

In certain embodiments, such as for uncrewed aerial system (“UAS”) services, a UAS service supplier (“USS”) uncrewed aerial vehicle (“UAV”) authorization and/or authentication (“UUAA”) may be performed at: 1) registration (“UUAA-MM”); 2) protocol data unit (“PDU”) session establishment (“UUAA-SM”); or 3) at the time of UUAA, the user equipment's (“UE's”) aerial subscription must be obtained to determine whether the UE is allowed or not-allowed for the UAS services. The UE's aerial subscription information may be provided to a radio access network (“RAN”) at the time of successful UE's authorization and authentication for the UAS services. Since the AMF may inform the RAN about the UE's subscription information, it may not be clear if the UE is registered first as a regular UE and after a time period the UE attempts to get authorization for UAS services by establishing a PDU session and/or how the AMF realizes the UE's registration for UAS services to inform the RAN if the UE's aerial information allows for this registration.

In some embodiments, 3GPP has architecture enhancements for UAVs with the following functionality: 1) authentication and authorization of a UAV with the USS during fifth generation system (“5GS”) registration; 2) authentication and authorization of a UAV with the USS during PDU session establishment and protocol data network (“PDN”) connection establishment; 3) support for USS authorization of command and control (“C2”) communication; and/or 4) a reference model for UAV tracking, supporting three UAV tracking modes: a) UAV location reporting mode; b) UAV presence monitoring mode; and c) unknown UAV tracking mode. In various embodiments, a 3GPP system supports geofencing (e.g., for in-flight UAV) and geocaging (e.g., for UAV on the ground intending to fly) functionality in USS by providing enablers (e.g., location services, event notification to a subscribing USS, and so forth). In certain embodiments, geofencing and/or geocaging mechanisms are an air traffic control functionality performed by the USS. Moreover, the 3GPP system provides enablers to support geofencing and/or geocaging functionality in USS (e.g., location services, enablement of C2 connectivity, event notification to a subscribing USS, and so forth).

In various embodiments, an evolved packet system (“EPS”) capable of UAV services supports functionalities for: 1) subscription-based aerial UE identification and authorization, where a mobile management entity (“MME”) supporting the UAS services, retrieves the aerial UE subscription information from the home subscriber server (“HSS”) by using aerial-UE-subscription-information attribute value pair (“AVP”) from subscription-data AVP at the time of attach—the aerial subscription information is shared by an eNB by an aerial UE subscription information IE—the aerial subscription information may be passed on from one eNB to another eNB at the time of handover by using the aerial UE subscription information IE; 2) height reporting based on an event that the UE's altitude has crossed a network-configured reference altitude threshold; 3) interference detection based on a measurement reporting that is triggered if a configured number of cells (e.g., larger than one) fulfils the triggering criteria simultaneously; 4) signaling of flight path information from the UE to an evolved universal terrestrial radio access network (“E-UTRAN”); 5) location information reporting including a UE's horizontal and vertical velocity; and 6) open loop power control enhancements including UE specific pathloss compensation factor and an extended range of nominal target received power.

In certain embodiments, a UAV uses 3GPP access (e.g., LTE, new radio (“NR”)) for 3GPP UAV related operations. In some embodiments, an SMF+PGW-C implements various 3GPP functions such as: 1) triggering a UUAA-SM procedure for a UE requiring UAV authentication and authorization by a USS if requesting user plane resources for UAV operation, or if the USS and/or uncrewed aerial system traffic management (“UTM”) that authenticated the UAV triggers a re-authentication; and/or 2) triggering the authorization of pairing between a UAV and a networked UAV controller (“UAVC”) or a UAVC that connects to the UAV via internet connectivity during the establishment of the PDN connection and/or PDU session for C2 communication.

In some embodiments, an SMF+PGW-C has also access to HSS+UDM where it can access the UE's aerial subscription information from the HSS via the UDM.

In a first embodiment, a UUAA is performed for 5GS at a time of UE registration, UUAA-MM.

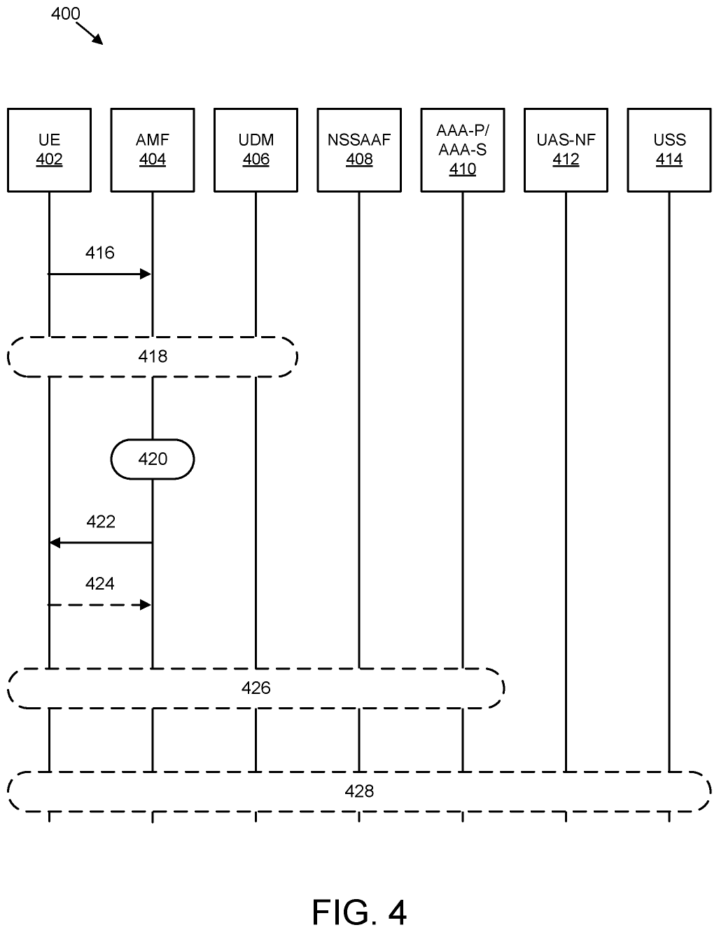

FIG. 4 is a schematic block diagram illustrating one embodiment of a system 400 for UUAA in the context of a registration procedure (e.g., UUAA-MM). The system 400 includes a UE 402, an AMF 404, a UDM 406, a network slice-specific authentication and authorization function (“NSSAAF”) 408, an authorization, authentication, and accounting (“AAA”) protocol (“P”) (“AAA-P”) and/or AAA server (“S”) (“AAA-S”) (“AAA-P/AAA-S”) 410, a UAS NF (“UAS-NF”) 412, and a USS 414. Each of the communications of the system 400 may include one or more messages.

In a first communication 416, the UE 402 transmits a registration request. In a second communication 418, primary authentication is performed. The AMF 404 determines 420 whether UUAA is required for UAV. In a third communication 422, a registration accept message is transmitted from the AMF 404 to the UE 402. Further, in a fourth communication 424, a registration complete message is transmitted to the AMF 404 from the UE 402. In a fifth communication 426, NSSAA procedures are performed. Moreover, in a sixth communication 428, UUAA-MM is performed.

In step 420, the AMF 404 may get the UE's aerial subscription information prior to performing UUAA-MM in step 428. In some embodiments, the AMF 404 gets the information from the UDM 406 according to various embodiments described herein. In various embodiments, the UDM 406 requires to get the information from a UDR according to some embodiments described herein.

In a second embodiment, a UUAA is performed for 5GS at a time of protocol data unit (“PDU”) session establishment, UUAA-SM.

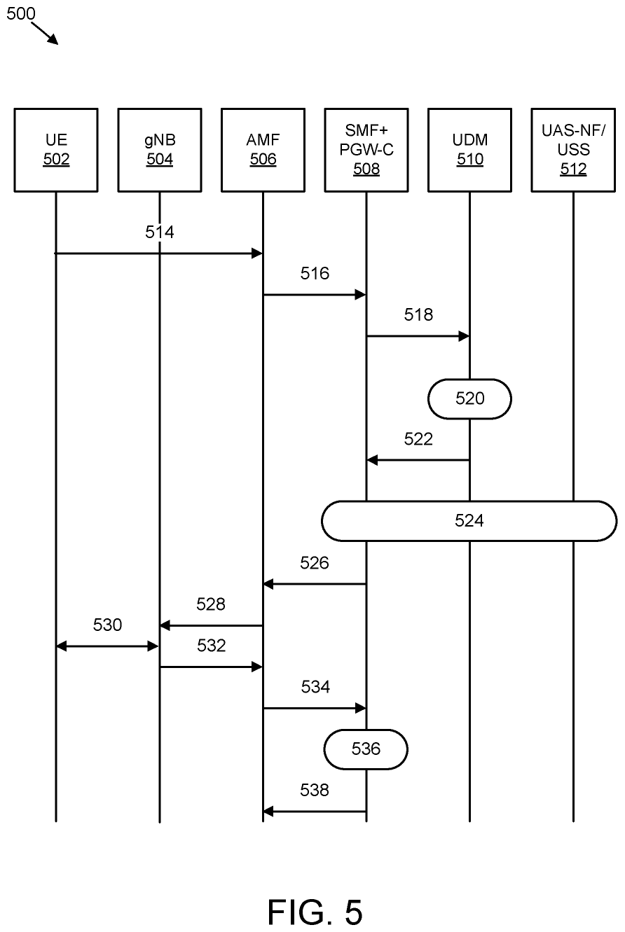

FIG. 5 is a schematic block diagram illustrating one embodiment of a system 500 for UUAA performed at a time of PDU session establishment in 5GS. The system 500 includes a UE 502, a gNB 504, an AMF 506, a session and mobility management function (“SMF”) plus a packet data network (“PDN”) gateway (“PGW”) controller (“PGW-C”) (“SMF+PGW-C”) 508, a UDM 510, and a UAS network function (“NF”) (“UAS-NF”) and/or USS (“UAS-NF/USS”) 512. Each of the communications of the system 500 may include one or more messages.

In a first communication 514, the UE 502 constructs a PDU SESSION ESTABLISHMENT REQUEST message including required parameters for UUAA (e.g., civil aviation administration (“CAA”) level UAV identifier (“ID”), USS server address, and/or UUAA aviation payload). The PDU SESSION ESTABLISHMENT REQUEST message may be transmitted as a part of a payload container information element (“IE”) of an UL non-access stratum (“NAS”) transport message with the payload container type set to the value of N1 SM information. The UE payload container IE may also include an optional IE set to the value of the service-level-AA container information, where the purpose of the service-level-AA container information IE may be to convey the UAS services related information for the PDU session.

In certain embodiments, a service-level-AA container information IE may be coded as shown in Table 1 and Table 2. In some embodiments, a service-level-AA container information IE may be a type 1 IE.

TABLE 1
Service-level-AA container information IE bit layout

| | | | | | | | |
|---|---|---|---|---|---|---|---|
| 8 | 7 | 6 | 5 | 4 | 3 | 2 | 1 |

| | | |
|---|---|---|
| Service-level-AA container | Service-level-AA container | octet 1 |
| information IEI | information value | |

TABLE 2
Service-level-AA container information IE
Service-level-AA container information value (octet 1, bit 1 to bit 4)

| Bits | | | | |
|---|---|---|---|---|
| 4 | 3 | 2 | 1 | |
| 0 | 0 | 0 | 0 | No additional information |
| 0 | 0 | 0 | 1 | UUAA request |

All other values are spare.

In the first communication 514, the UE 502 sends the constructed PDU SESSION ESTABLISHMENT message towards the AMF 506.

In some embodiments, upon receipt of the UL NAS transport message, the AMF 506 may check the optional IE within the payload container IE to find out it is set to the service-level-AA container information with the value of UUAA request. The AMF 506 may require obtaining the aerial subscription information to find out whether the UE 502 is allowed to use UAS functions. For that, the AMF 506 queries the subscribed aerial subscription data for the UE 502. In various embodiments, a resource name (e.g., AerialSubscriptionData) may be included as shown in Table 3.

TABLE 3
Resources and methods overview

| | | HTTP | |
|---|---|---|---|
| | | method | |
| | | or | |
| Resource name | | custom | |
| (Archetype) | Resource URI | operation | Description |
| AerialSubscription- | /{ueld}/aerial-data | GET | Retrieve the |
| Data | | | UE's aerial |
| | | | subscription data |

The resource (e.g., AerialSubscriptionData) may be defined as: 1) Resource: AerialSubscriptionData; 2) Description: this resource represents the subscribed aerial subscription data for a 3GPP-UAV-ID—it is queried by the AMF or SMF at the time of UUAA-MM or UUAA-SM; and/or 3) Resource Definition: Resource URI: {apiRoot}/nudm-asd/<apiVersion>/{ueId}/aerial-data. Table 4 shows one embodiment of resource URI variables for this resource.

TABLE 4
Resource URI variables for this resource

| Name | Data type | Definition |
|---|---|---|
| apiRoot | string | predefined |
| ueld | VarUeld | Represents a subscription permanent |
| | | identifier or a generic public subscription |
| | | identifier pattern, such as a pattern of type |
| | | VarUeld |

The resource (e.g., AerialSubscriptionData) may also include a GET resource standard method. Table 5 shows one embodiment of data structures supported by a GET request body on this resource. Further, Table 6 shows one embodiment of data structures supported by a GET response body on this resource.

TABLE 5
Data structures supported by the GET request body

| Data type | P | Cardinality | Description |
|---|---|---|---|
| n/a | | | |

TABLE 6
Data structures supported by the GET response body

| | | | Response | |
|---|---|---|---|---|
| Data type | P | Cardinality | codes | Description |
| AerialSubscription- | M | 1 | 200 OK | Upon success, a |
| Data | | | | response body |
| | | | | containing the |
| | | | | Aerial Subscription |
| | | | | Data shall be returned. |
| ProblemDetails | O | 0 . . . 1 | 404 Not | The “cause” attribute |
| | | | Found | may be used to |
| | | | | indicate one of the |
| | | | | following application |
| | | | | errors: |
| | | | | USER_NOT_FOUND |
| | | | | DATA_NOT_FOUND |

The resource (e.g., AerialSubscriptionData) may be added to Table 7 as shown.

TABLE 7
Nudm_SDM specific Data Types

| Data type | Clause defined | Description |
|---|---|---|
| AerialSubscription Data | | |
| AerialSubscribed | Table 8 | |

Table 8 shows one embodiment of a data type AerialSubscribed.

TABLE 8
Definition of type AerialSubscribed

| Attribute name | Data type | P | Cardinality | Description |
|---|---|---|---|---|
| aerialSubscribed | AerialSubscribed | M | 1 . . . N | Indicates whether |
| | | | | the UE subscription |
| | | | | allows UAS |
| | | | | aerial service. |

Table 9 shows one embodiment of simple data types.

TABLE 9
Simple data types

| Type Name | Type Definition | Description |
|---|---|---|
| AerialSubscribed | boolean | Indicates whether the UE |
| | | subscription allows UAS |
| | | aerial service |

In certain embodiments, upon receipt of the UE's 502 aerial subscription: 1) if the UE's 502 aerial subscription is not valid, the AMF 506 may reject the PDU session establishment by: a) including the PDU session ID in the PDU session ID IE, b) setting the payload container type IE to “N1 SM information”, c) setting the payload container information element to a selected 5GSM message, describing that the PDU SESSION ESTABLISHMENT REQUEST message was not forwarded due to invalid aerial subscription, and d) setting the 5GMM cause IE to a selected 5GMM cause number having a value such as “payload was not forwarded” or “payload was not forwarded due to invalid aerial subscription”; or 2) if the UE's 502 aerial subscription is valid, the AMF 506 may forward now or may wait until the successful result of UUAA performed by SMF to forward the UE's 502 aerial subscription information to the gNB 504 as a new IE in PDU SESSION RESOURCE SETUP REQUEST. In some embodiments, the AMF 506 uses POST to forward the data for the PDU session establishment to the SMF+PGW-C 508.

In a third communication 518, for the SMF+PGW-C 508 to trigger the UUAA, it may obtain aerial subscription information to find out whether the UE 502 is allowed to use UAS functions. The SMF+PGW-C 508 may query the subscribed aerial subscription data for the UE 502 and may use a resource name (e.g., AerialSubscriptionData) as shown in Table 10 for resources and methods overview.

TABLE 10
Resources and methods overview

| | | HTTP | |
|---|---|---|---|
| | | method | |
| | | or | |
| Resource name | | custom | |
| (Archetype) | Resource URI | operation | Description |
| AerialSubscriptionData | /{ueld}/aerial-data | GET | Retrieve the |
| | | | UE's aerial |
| | | | subscription data |

The resource (e.g., AerialSubscriptionData) may be defined as: 1) Resource: AerialSubscriptionData; 2) Description—this resource represents the subscribed aerial subscription data for a 3GPP-UAV-ID—it is queried by the AMF 506 or SMF at the time of UUAA-MM or UUAA-SM; and/or 3) Resource Definition: Resource URI: {apiRoot}/nudm-asd/<apiVersion>/{ueId}/aerial-data. One embodiment of the resource URI variables for this resource is shown in Table 11.

TABLE 11
Resource URI variables

| Name | Data type | Definition |
|---|---|---|
| apiRoot | string | predefined |
| ueld | VarUeld | Represents a subscription permanent |
| | | identifier (“SUPI”) or a generic public |
| | | subscription identifier (“GPSI”) pattern, |
| | | such as a pattern of type VarUeld |

The resource (e.g., AerialSubscriptionData) may also include a GET resource standard method. Table 12 shows one embodiment of data structures supported by a GET request body on this resource. Further, Table 13 shows one embodiment of data structures supported by a GET response body on this resource.

TABLE 12
Data structures supported by the GET request body

| Data type | P | Cardinality | Description |
|---|---|---|---|
| n/a | | | |

TABLE 13
Data structures supported by the GET response body

| | | | Response | |
|---|---|---|---|---|
| Data type | P | Cardinality | codes | Description |
| Aerial- | M | 1 | 200 OK | Upon success, a response |
| SubscriptionData | | | | body containing the |
| | | | | Aerial Subscription Data |
| | | | | shall be returned. |
| ProblemDetails | O | 0 . . . 1 | 404 Not | The “cause” attribute may |
| | | | Found | be used to indicate one of |
| | | | | the following application |
| | | | | errors: |
| | | | | USER_NOT_FOUND |
| | | | | DATA_NOT_FOUND |

The resource (e.g., AerialSubscriptionData) may be added to Table 14 as shown.

TABLE 14
Nudm_SDM specific Data Types

| Data type | Clause defined | Description |
|---|---|---|
| AerialSubscription Data | | |
| AerialSubscribed | Table 15 | |

Table 15 shows one embodiment of a data type AerialSubscribed.

TABLE 15
Definition of type AerialSubscribed

| Attribute name | Data type | P | Cardinality | Description |
|---|---|---|---|---|
| aerialSubscribed | AerialSubscribed | M | 1 . . . N | Indicates whether |
| | | | | the UE subscription |
| | | | | allows UAS |
| | | | | aerial service. |

Table 16 shows one embodiment of simple data types.

TABLE 16
Simple data types

| Type Name | Type Definition | Description |
|---|---|---|
| AerialSubscribed | boolean | Indicates whether the |
| | | UE subscription allows |
| | | UAS aerial service |

In some embodiments, the UDM 510 retrieves 520 the UE's 502 aerial subscription.

In a fourth communication 522, the UDM 510 provides the SMF+PGW-C 508 the aerial subscription information.

In a fifth communication 524, UUAA is performed.

In a sixth communication 526, upon completion of UUAA, if the UUAA is successful the SMF+PGW-C 508 creates a PDU SESSION ESTABLISHMENT ACCEPT message and forwards in a 201 OK created message to the AMF 506. If the UUAA is not successful, the SMF+PGW-C 508 creates a PDU SESSION ESTABLISHMENT REJECT message with an appropriate cause value to inform the UE 502 about the failure of the UUAA due to UE's 502 aerial subscription information. The AMF 506 therefore doesn't inform the RAN about the UE's 502 registration for UAS services.

In a seventh communication 528, upon receipt of 201 OK created message, the AMF 506 may forward the UE's 502 aerial subscription information to the gNB 504 as a new information element in PDU SESSION RESOURCE SETUP REQUEST. The AMF 506 may forward the UE's 502 aerial subscription information to the gNB 504 as a new IE in PDU SESSION RESOURCE SETUP REQUEST (e.g., based on Table 17).

TABLE 17
PDU SESSION RESOURCE SETUP REQUEST

| | | | | | | |
|---|---|---|---|---|---|---|
| | | | IE type and | Semantics | | Assigned |
| IE/Group Name | Presence | Range | reference | description | Criticality | Criticality |

| | | | | |
|---|---|---|---|---|
| Aerial UE | ◯ | 9.3.1.X | YES | ignore |
| subscription | | | | |
| information | | | | |

In certain embodiments, an aerial UE subscription information IE may be used by the gNB 504 to know if the UE 502 is allowed to use a UAS function and indicates how the UE 502 is identified for UAS services by a 3GPP network.

Table 18 illustrates one embodiment of information corresponding to an aerial subscribed IE.

TABLE 18
Information corresponding to an aerial subscribed IE

| | | | IE type and | Semantics |
|---|---|---|---|---|
| IE/Group Name | Presence | Range | reference | description |
| aerialSubscribed | M | | ENUMERATED | |
| | | | (allowed, not | |
| | | | allowed, . . . ) | |

In an eighth communication 530, the gNB 504 and the UE 502 exchange access specific signaling.

In a nineth communication 532, a PDU SESSION RESOURCE SETUP RESPONSE is sent. Further, in a tenth communication 534, a POST transmission is made. Moreover, the SMF+PGW-C 508 may perform 536 an N4 session modification procedure with a UPF. In an eleventh communication 538, a 200 OK response is sent to the AMF 506. Steps 532 through 538 may be used to establish uplink and downlink data.

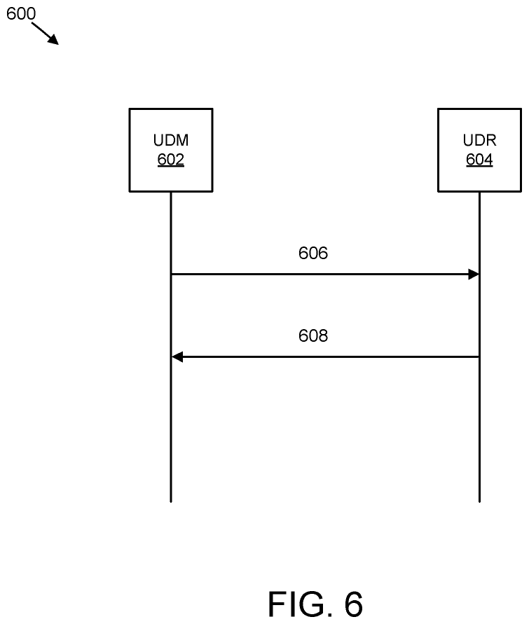

FIG. 6 is a schematic block diagram illustrating one embodiment of a system 600 for obtaining aerial subscription information. The system 600 includes a UDM 602 and a UDR 604. Each of the communications of the system 600 may include one or more messages. The UDM 602 may retrieve the aerial subscription information from the UDR 604.

In a first communication 606, the UDM 602 attempts to fetch the UE's aerial subscription information from the UDR 604 (e.g., with a GET message).

In a second communication 608, the UDR 604 provides the UE's aerial subscription to the UDM 602 (e.g., with a 200 OK message).

To implement steps 606 and 608, a resource name (e.g., AerialSubscriptionData) as shown in Table 19 may be used.

TABLE 19
Resources and methods overview

| | | HTTP | |
|---|---|---|---|
| Resource name | Resource URI | method | Description |
| AerialSubscription Data | /subscription-data/ | GET | Retrieve a UE's |
| | {ueld}/aerial-data | | aerial subscription |
| | | | data |

The resource (e.g., AerialSubscriptionData) may be defined as: 1) Resource: AerialSubscriptionData; 2) Description—this resource represents the subscribed aerial subscription data for a UE ID—it may be queried by the UDM 602; and/or 3) Resource Definition: Resource URI: {apiRoot}/nudr-asd/<api Version>/subscription-data/{ueId}/aerial-data. One embodiment of the resource URI variables for this resource is shown in Table 20.

TABLE 20
Resource URI variables for this resource

| Name | Definition |
|---|---|
| apiRoot | predefined |
| ueld | Represents the subscription identifier SUPI |
| | or GPSI pattern, such as a pattern of |
| | type VarUeld |
| servingPlmnId | Represents the Serving public land mobile |
| | network (“PLMN”) ID (<MCC><MNC>) |
| | pattern: “\hat{ }[0-9]{5,6}$” |

The resource (e.g., AerialSubscriptionData) may also include a GET resource standard method. Table 21 shows one embodiment of data structures supported by a GET request body on this resource. Further, Table 22 shows one embodiment of data structures supported by a GET response body on this resource. URI query parameters specified Tables 22 and 23 may be supported.

TABLE 21
Data structures supported by the GET request body

| Data type | P | Cardinality | Description |
|---|---|---|---|
| n/a | | | |

TABLE 22
Data structures supported by the GET response body

| | | | Response | |
|---|---|---|---|---|
| Data type | P | Cardinality | codes | Description |
| Aerial- | M | 1 | 200 OK | Upon success, a |
| SubscriptionData | | | | response body containing |
| | | | | the aerial Subscription |
| | | | | Data for the user shall be |
| | | | | returned. |
| ProblemDetails | O | 0 . . . 1 | 404 Not | The “cause” attribute may |
| | | | Found | be used to indicate one of |
| | | | | the following application |
| | | | | errors: |
| | | | | USER_NOT_FOUND |
| | | | | DATA_NOT_FOUND |

The resource (e.g., AerialSubscriptionData) may be added to Table 23 as shown.

TABLE 23
Nudr re-used Data Types

| Data type | Clause defined | Description |
|---|---|---|
| AerialSubscription Data | | A UE's aerial |
| | | subscription data |
| AerialSubscribed | | |

In a third embodiment, a SMF+PGW-C informs an AMF about a UE's aerial subscription information so the AMF can inform a RAN about it.

In a first step of the third embodiment, the UE constructs a PDU SESSION ESTABLISHMENT REQUEST message including required parameters for UUAA (e.g., CAA level UAVID, USS server address, and/or UUAA aviation payload). The UE sends the constructed PDU session establishment request message towards the AMF.

In a second step of the third embodiment, the AMF uses a POST to forward the required data for the PDU session establishment to the SMF+PGW-C.

In a third step of the third embodiment, for the SMF+PGW-C to trigger the UUAA, it may be required to obtain the aerial subscription information to find out whether the UE is allowed to use UAS functions. For that the SM+PGW-C queries the subscribed aerial subscription data for the UE. In certain embodiments, a new resource name may be used for resources and methods overview with details as found in the second embodiment.

In a fourth step of the third embodiment, the UDM provides the SMF+PGW-C with the aerial subscription information AerialSubscriptionData in a 201 OK message.

In a fifth step of the third embodiment, upon completion of UUAA, if the UUAA is successful, the SMF+PGW-C creates a PDU SESSION ESTABLISHMENT ACCEPT message and forwards in a 201 OK created message to the AMF. If the UUAA is not successful, the SMF+PGW-C creates a PDU SESSION ESTABLISHMENT REJECT message with an appropriate cause value to inform the UE about the failure of the UUAA due to UE's aerial subscription information. The AMF therefore doesn't inform the RAN about the UE's registration for UAS services.

In some embodiments, the SMF+PGW-C forwards the 201 OK created message including the PduSessionCreatedData to the AMF. The PduSessionCreatedData includes an attribute for aerial subscription information added to Table 24 and Table 25 as shown.

TABLE 24
Definition of type PduSessionCreatedData

| Attribute name | Data type | P | Cardinality | Description | Applicability |
|---|---|---|---|---|---|
| aerialSubscribed | AerialSubscribed | C | 0 . . . 1 | This IE shall be present if the UUAA- | |
| | | | | SM has been successful. If present, | |
| | | | | it shall indicate whether the UE | |
| | | | | subscription allows UAS aerial | |
| | | | | service | |

TABLE 25
Simple data types

| Type Name | Type Definition | Description |
|---|---|---|
| AerialSubscribed | boolean | Indicates whether the UE |
| | | subscription allows UAS aerial |
| | | service |

In a sixth step of the third embodiment, upon receipt of the 201 OK created message, the AMF may forward the UE's aerial subscription information to the gNB as a new IE in a PDU SESSION RESOURCE SETUP REQUEST.

In a seventh step of the third embodiment, the gNB and the UE exchanges access specific signaling exchange.

In an eighth step of the third embodiment, uplink and downlink data is established.

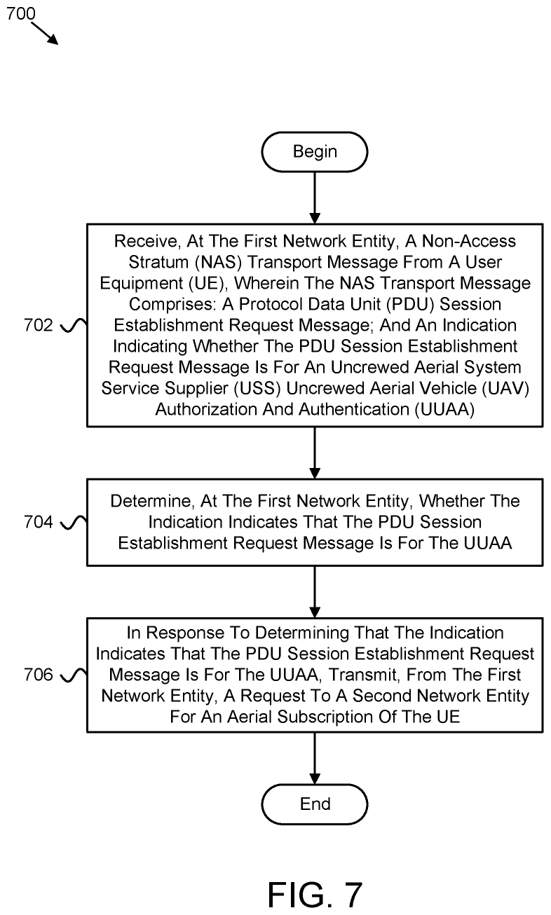

FIG. 7 is a flow chart diagram illustrating one embodiment of a method 700 for requesting aerial subscription information. In some embodiments, the method 700 is performed by an apparatus, such as the network unit 104. In certain embodiments, the method 700 may be performed by a processor executing program code, for example, a microcontroller, a microprocessor, a CPU, a GPU, an auxiliary processing unit, a FPGA, or the like.

In various embodiments, the method 700 includes receiving 702, at a first network entity, a non-access stratum (NAS) transport message from a user equipment (UE). The NAS transport message includes: a protocol data unit (PDU) session establishment request message; and an indication indicating whether the PDU session establishment request message is for an uncrewed aerial system service supplier (USS) uncrewed aerial vehicle (UAV) authorization and authentication (UUAA). In some embodiments, the method 700 includes determining 704, at the first network entity, whether the indication indicates that the PDU session establishment request message is for the UUAA. In certain embodiments, the method 700 includes, in response to determining that the indication indicates that the PDU session establishment request message is for the UUAA, transmitting 706, from the first network entity, a request to a second network entity for an aerial subscription of the UE.

In certain embodiments, the first network entity comprises an access and mobility management function (AMF) and the second network entity comprises a unified data management (UDM). In some embodiments, the method 700 further comprises receiving, at the first network entity, the aerial subscription of the UE in a response message from the second network entity. In various embodiments, the method 700 further comprises transmitting, from the first network entity, the aerial subscription of the UE to a third network entity.

In one embodiment, the third network entity comprises a base station. In certain embodiments, in response to the aerial subscription comprising an allowed value, the response message triggers that the third network entity to provide the UE at least one feature, and the at least one feature comprises: an aerial height, wherein the aerial height comprising a lower threshold and an upper threshold; location information, wherein the location information comprises a horizontal velocity and a vertical velocity; flight path information, wherein the flight path information is signaled from a UAV; an open loop power control, wherein the open loop power control is used for calculating a pathloss compensation factor; an interference detection, wherein the interference detection is based on UAV reporting measurements, wherein the UAV reporting measurements are triggered by received signal strengths being above a configured threshold; or some combination thereof.

In some embodiments, the NAS transport message comprises: a payload container type set to a value indicating N1 session management (SM) information; and a payload container information element (IE) comprising: the PDU session establishment request message comprising a service-level AA container IE comprising a civil aviation administration level (CAA-level) UAV identifier (ID) and: a USS address; a UUAA aviation payload; or a combination thereof; and an optional IE set to a value of service-level-AA container information, wherein the value of the service-level-AA container information comprises a UUAA request.

In various embodiments, the aerial subscription comprises: an allowed value; or a not allowed value, wherein the allowed value indicates a permission to use an uncrewed aerial system (UAS) service and the not allowed value comprises a lack of permission to use the UAS service. In one embodiment, the indication comprises an optional IE of a payload container entry within a payload container IE.

In certain embodiments, the optional IE comprises service-level-AA container information. In some embodiments, the optional IE comprises a value that indicates the PDU session establishment request message is for UUAA.

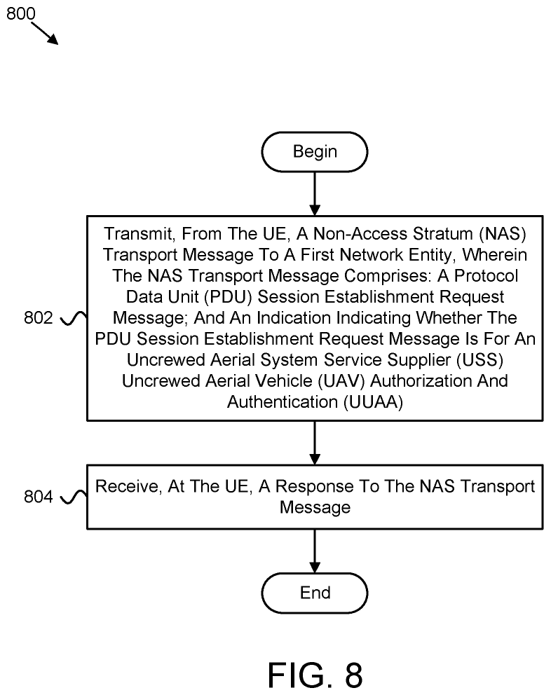

FIG. 8 is a flow chart diagram illustrating another embodiment of a method 800 for requesting aerial subscription information. In some embodiments, the method 800 is performed by an apparatus, such as the remote unit 102. In certain embodiments, the method 800 may be performed by a processor executing program code, for example, a microcontroller, a microprocessor, a CPU, a GPU, an auxiliary processing unit, a FPGA, or the like.

In various embodiments, the method 800 includes transmitting 802, from a UE, a non-access stratum (NAS) transport message to a first network entity. The NAS transport message includes: a protocol data unit (PDU) session establishment request message; and an indication indicating whether the PDU session establishment request message is for an uncrewed aerial system service supplier (USS) uncrewed aerial vehicle (UAV) authorization and authentication (UUAA). In some embodiments, the method 800 includes receiving 804, at the UE, a response to the NAS transport message.

In certain embodiments, the first network entity comprises an access and mobility management function (AMF). In some embodiments, the NAS transport message comprises: a payload container type set to a value indicating N1 session management (SM) information; and a payload container information element (IE) comprising: the PDU session establishment request message comprising a service-level AA container IE comprising a civil aviation administration level (CAA-level) UAV identifier (ID) and: a USS address; a UUAA aviation payload; or a combination thereof; and an optional IE set to a value of service-level-AA container information, wherein the value of the service-level-AA container information comprises a UUAA request.

In various embodiments, the indication comprises an optional IE of a payload container entry within a payload container IE. In one embodiment, the optional IE comprises service-level-AA container information. In certain embodiments, the optional IE comprises a value, and the value is for UUAA.

In one embodiment, an apparatus comprises a first network entity. The apparatus further comprises: a receiver that receives, at the first network entity, a non-access stratum (NAS) transport message from a user equipment (UE), wherein the NAS transport message comprises: a protocol data unit (PDU) session establishment request message; and an indication indicating whether the PDU session establishment request message is for an uncrewed aerial system service supplier (USS) uncrewed aerial vehicle (UAV) authorization and authentication (UUAA); a processor that determines, at the first network entity, whether the indication indicates that the PDU session establishment request message is for the UUAA; and a transmitter that, in response to determining that the indication indicates that the PDU session establishment request message is for the UUAA, transmits, from the first network entity, a request to a second network entity for an aerial subscription of the UE.

In certain embodiments, the first network entity comprises an access and mobility management function (AMF) and the second network entity comprises a unified data management (UDM).

In some embodiments, the receiver receives, at the first network entity, the aerial subscription of the UE in a response message from the second network entity.

In various embodiments, the transmitter transmits, from the first network entity, the aerial subscription of the UE to a third network entity.

In one embodiment, the third network entity comprises a base station.

In certain embodiments, in response to the aerial subscription comprising an allowed value, the response message triggers that the third network entity to provide the UE at least one feature, and the at least one feature comprises: an aerial height, wherein the aerial height comprising a lower threshold and an upper threshold; location information, wherein the location information comprises a horizontal velocity and a vertical velocity; flight path information, wherein the flight path information is signaled from a UAV; an open loop power control, wherein the open loop power control is used for calculating a pathloss compensation factor; an interference detection, wherein the interference detection is based on UAV reporting measurements, wherein the UAV reporting measurements are triggered by received signal strengths being above a configured threshold; or some combination thereof.

In some embodiments, the NAS transport message comprises: a payload container type set to a value indicating N1 session management (SM) information; and a payload container information element (IE) comprising: the PDU session establishment request message comprising a service-level AA container IE comprising a civil aviation administration level (CAA-level) UAV identifier (ID) and: a USS address; a UUAA aviation payload; or a combination thereof; and an optional IE set to a value of service-level-AA container information, wherein the value of the service-level-AA container information comprises a UUAA request.

In various embodiments, the aerial subscription comprises: an allowed value; or a not allowed value, wherein the allowed value indicates a permission to use an uncrewed aerial system (UAS) service and the not allowed value comprises a lack of permission to use the UAS service.

In one embodiment, the indication comprises an optional IE of a payload container entry within a payload container IE.

In certain embodiments, the optional IE comprises service-level-AA container information.

In some embodiments, the optional IE comprises a value that indicates the PDU session establishment request message is for UUAA.

In one embodiment, a method of a first network entity comprises: receiving, at the first network entity, a non-access stratum (NAS) transport message from a user equipment (UE), wherein the NAS transport message comprises: a protocol data unit (PDU) session establishment request message; and an indication indicating whether the PDU session establishment request message is for an uncrewed aerial system service supplier (USS) uncrewed aerial vehicle (UAV) authorization and authentication (UUAA); determining, at the first network entity, whether the indication indicates that the PDU session establishment request message is for the UUAA; and, in response to determining that the indication indicates that the PDU session establishment request message is for the UUAA, transmitting, from the first network entity, a request to a second network entity for an aerial subscription of the UE.

In certain embodiments, the first network entity comprises an access and mobility management function (AMF) and the second network entity comprises a unified data management (UDM).

In some embodiments, the method further comprises receiving, at the first network entity, the aerial subscription of the UE in a response message from the second network entity.

In various embodiments, the method further comprises transmitting, from the first network entity, the aerial subscription of the UE to a third network entity.

In one embodiment, the third network entity comprises a base station.

In certain embodiments, in response to the aerial subscription comprising an allowed value, the response message triggers that the third network entity to provide the UE at least one feature, and the at least one feature comprises: an aerial height, wherein the aerial height comprising a lower threshold and an upper threshold; location information, wherein the location information comprises a horizontal velocity and a vertical velocity; flight path information, wherein the flight path information is signaled from a UAV; an open loop power control, wherein the open loop power control is used for calculating a pathloss compensation factor; an interference detection, wherein the interference detection is based on UAV reporting measurements, wherein the UAV reporting measurements are triggered by received signal strengths being above a configured threshold; or some combination thereof.

In some embodiments, the NAS transport message comprises: a payload container type set to a value indicating N1 session management (SM) information; and a payload container information element (IE) comprising: the PDU session establishment request message comprising a service-level AA container IE comprising a civil aviation administration level (CAA-level) UAV identifier (ID) and: a USS address; a UUAA aviation payload; or a combination thereof; and an optional IE set to a value of service-level-AA container information, wherein the value of the service-level-AA container information comprises a UUAA request.

In various embodiments, the aerial subscription comprises: an allowed value; or a not allowed value, wherein the allowed value indicates a permission to use an uncrewed aerial system (UAS) service and the not allowed value comprises a lack of permission to use the UAS service.

In one embodiment, the indication comprises an optional IE of a payload container entry within a payload container IE.

In certain embodiments, the optional IE comprises service-level-AA container information.

In some embodiments, the optional IE comprises a value that indicates the PDU session establishment request message is for UUAA.

In one embodiment, an apparatus comprises a user equipment (UE). The apparatus further comprises: a transmitter that transmits, from the UE, a non-access stratum (NAS) transport message to a first network entity, wherein the NAS transport message comprises: a protocol data unit (PDU) session establishment request message; and an indication indicating whether the PDU session establishment request message is for an uncrewed aerial system service supplier (USS) uncrewed aerial vehicle (UAV) authorization and authentication (UUAA); and a receiver that receives, at the UE, a response to the NAS transport message.

In certain embodiments, the first network entity comprises an access and mobility management function (AMF).

In some embodiments, the NAS transport message comprises: a payload container type set to a value indicating N1 session management (SM) information; and a payload container information element (IE) comprising: the PDU session establishment request message comprising a service-level AA container IE comprising a civil aviation administration level (CAA-level) UAV identifier (ID) and: a USS address; a UUAA aviation payload; or a combination thereof; and an optional IE set to a value of service-level-AA container information, wherein the value of the service-level-AA container information comprises a UUAA request.

In various embodiments, the indication comprises an optional IE of a payload container entry within a payload container IE.

In one embodiment, the optional IE comprises service-level-AA container information.

In certain embodiments, the optional IE comprises a value, and the value is for UUAA.

In one embodiment, a method of a user equipment (UE) comprises: transmitting, from the UE, a non-access stratum (NAS) transport message to a first network entity, wherein the NAS transport message comprises: a protocol data unit (PDU) session establishment request message; and an indication indicating whether the PDU session establishment request message is for an uncrewed aerial system service supplier (USS) uncrewed aerial vehicle (UAV) authorization and authentication (UUAA); and receiving, at the UE, a response to the NAS transport message.

In certain embodiments, the first network entity comprises an access and mobility management function (AMF).

In some embodiments, the NAS transport message comprises: a payload container type set to a value indicating N1 session management (SM) information; and a payload container information element (IE) comprising: the PDU session establishment request message comprising a service-level AA container IE comprising a civil aviation administration level (CAA-level) UAV identifier (ID) and: a USS address; a UUAA aviation payload; or a combination thereof; and an optional IE set to a value of service-level-AA container information, wherein the value of the service-level-AA container information comprises a UUAA request.

In various embodiments, the indication comprises an optional IE of a payload container entry within a payload container IE.

In one embodiment, the optional IE comprises service-level-AA container information.

In certain embodiments, the optional IE comprises a value, and the value is for UUAA.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus for performing a network function of a first network entity, the apparatus comprising:
at least one memory; and
at least one processor coupled with the at least one memory and configured to cause the apparatus to:
receive, at the first network entity, a non-access stratum (NAS) transport message from a user equipment (UE), wherein the NAS transport message comprises:
a protocol data unit (PDU) session establishment request message; and
an indication indicating whether the PDU session establishment request message is for an uncrewed aerial system service supplier (USS) uncrewed aerial vehicle (UAV) authorization and authentication (UUAA);
determine, at the first network entity, whether the indication indicates that the PDU session establishment request message is for the UUAA; and
in response to determining that the indication indicates that the PDU session establishment request message is for the UUAA, transmit, from the first network entity, a request to a second network entity for an aerial subscription of the UE.

2. The apparatus of claim 1, wherein the first network entity comprises an access and mobility management function (AMF) and the second network entity comprises a unified data management (UDM).

3. The apparatus of claim 1, wherein the at least one processor is configured to cause the apparatus to receive, at the first network entity, the aerial subscription of the UE in a response message from the second network entity.

4. The apparatus of claim 3, wherein the at least one processor is configured to cause the apparatus to transmit, from the first network entity, the aerial subscription of the UE to a third network entity.

5. The apparatus of claim 4, wherein the third network entity comprises a base station.

6. The apparatus of claim 4, wherein, in response to the aerial subscription comprising an allowed value, the response message triggers that the third network entity to provide the UE at least one feature, and the at least one feature comprises:
an aerial height, wherein the aerial height comprising a lower threshold and an upper threshold;
location information, wherein the location information comprises a horizontal velocity and a vertical velocity;
flight path information, wherein the flight path information is signaled from a UAV;
an open loop power control, wherein the open loop power control is used for calculating a pathloss compensation factor;
an interference detection, wherein the interference detection is based on UAV reporting measurements, wherein the UAV reporting measurements are triggered by received signal strengths being above a configured threshold;
or a combination thereof.

7. The apparatus of claim 1, wherein the NAS transport message comprises:
a payload container type set to a value indicating N1 session management (SM) information; and
a payload container information element (IE) comprising:
the PDU session establishment request message comprising a service-level AA container IE comprising a civil aviation administration level (CAA-level) UAV identifier (ID) and:
a USS address;
a UUAA aviation payload;
or a combination thereof; and
an optional IE set to a value of service-level-AA container information, wherein the value of the service-level-AA container information comprises a UUAA request.

8. The apparatus of claim 1, wherein the aerial subscription comprises:
an allowed value; or
a not allowed value, wherein the allowed value indicates a permission to use an uncrewed aerial system (UAS) service and the not allowed value comprises a lack of permission to use the UAS service.

9. The apparatus of claim 1, wherein the indication comprises an optional IE of a payload container entry within a payload container IE.

10. The apparatus of claim 9, wherein the optional IE comprises service-level-AA container information.

11. The apparatus of claim 9, wherein the optional IE comprises a value that indicates the PDU session establishment request message is for UUAA.

12. (canceled)

13. A user equipment (UE), comprising:
at least one memory; and
at least one processor coupled with the at least one memory and configured to cause the UE to:
transmit, from the UE, a non-access stratum (NAS) transport message to a first network entity, wherein the NAS transport message comprises:
a protocol data unit (PDU) session establishment request message; and
an indication indicating whether the PDU session establishment request message is for an uncrewed aerial system service supplier (USS) uncrewed aerial vehicle (UAV) authorization and authentication (UUAA); and
receive, at the UE, a response to the NAS transport message.

14. The UE of claim 13, wherein the NAS transport message comprises:
a payload container type set to a value indicating N1 session management (SM) information; and
a payload container information element (IE) comprising:
the PDU session establishment request message comprising a service-level AA container IE comprising a civil aviation administration level (CAA-level) UAV identifier (ID) and:
a USS address;
a UUAA aviation payload;
or a combination thereof; and
an optional IE set to a value of service-level-AA container information, wherein the value of the service-level-AA container information comprises a UUAA request.

15. The UE of claim 13, wherein:
the indication comprises an optional IE of a payload container entry within a payload container IE;
the optional IE comprises service-level-AA container information;
the optional IE comprises a value, and the value is for UUAA;
or a combination thereof.

16. A processor for wireless communication, comprising:
at least one controller coupled with at least one memory and configured to cause the processor to:
transmit, from a user equipment (UE), a non-access stratum (NAS) transport message to a first network entity, wherein the NAS transport message comprises:
a protocol data unit (PDU) session establishment request message; and
an indication indicating whether the PDU session establishment request message is for an uncrewed aerial system service supplier (USS) uncrewed aerial vehicle (UAV) authorization and authentication (UUAA); and
receive, at the UE, a response to the NAS transport message.

17. The processor of claim 16, wherein the NAS transport message comprises:
a payload container type set to a value indicating N1 session management (SM) information; and
a payload container information element (IE) comprising:
the PDU session establishment request message comprising a service-level AA container IE comprising a civil aviation administration level (CAA-level) UAV identifier (ID) and:
a USS address;
a UUAA aviation payload;
or a combination thereof; and
an optional IE set to a value of service-level-AA container information, wherein the value of the service-level-AA container information comprises a UUAA request.

18. The processor of claim 16, wherein:
the indication comprises an optional IE of a payload container entry within a payload container IE;
the optional IE comprises service-level-AA container information;
the optional IE comprises a value, and the value is for UUAA;
or a combination thereof.

19. A method performed by a user equipment (UE), the method comprising:
transmitting, from the UE, a non-access stratum (NAS) transport message to a first network entity, wherein the NAS transport message comprises:
a protocol data unit (PDU) session establishment request message; and
an indication indicating whether the PDU session establishment request message is for an uncrewed aerial system service supplier (USS) uncrewed aerial vehicle (UAV) authorization and authentication (UUAA); and
receiving, at the UE, a response to the NAS transport message.

20. The method of claim 19, wherein the NAS transport message comprises:
a payload container type set to a value indicating N1 session management (SM) information; and
a payload container information element (IE) comprising:
the PDU session establishment request message comprising a service-level AA container IE comprising a civil aviation administration level (CAA-level) UAV identifier (ID) and:
a USS address;
a UUAA aviation payload;
or a combination thereof; and
an optional IE set to a value of service-level-AA container information, wherein the value of the service-level-AA container information comprises a UUAA request.

21. The method of claim 19, wherein:
the indication comprises an optional IE of a payload container entry within a payload container IE;
the optional IE comprises service-level-AA container information;
the optional IE comprises a value, and the value is for UUAA;
or a combination thereof.
